(19) United States
(12) Patent Application Publication
(10) Pub. No.: US 2011/0170614 A1
(43) Pub. Date: Jul. 14, 2011

(54) VIDEO/AUDIO TRANSMISSION DEVICE AND VIDEO/AUDIO RECEPTION DEVICE

(76) Inventors: Eiichi Moriyama, Kyoto (JP); Takayuki Matsui, Osaka (JP)

(21) Appl. No.: 13/119,039

(22) PCT Filed: Sep. 28, 2009
(86) PCT No.: PCT/JP2009/004923

§ 371 Date: Mar. 15, 2011

(30) Foreign Application Priority Data
Oct. 9, 2008 (JP) 2008262627

(51) Int. Cl. H04N 7/26

(52) U.S. Cl. 375/240.25; 375/240.01; 375/E07.026

(57) ABSTRACT

A video/audio encoding unit encodes an inputted video/audio signal in a format compliant with a predetermined technical standard. A differential signal output unit outputs the encoded data in the form of a differential signal defined by the predetermined technical standard. The differential signal output unit appends the data encoded by the video/audio encoding unit to a data transmission unallocated region of a communication line defined by the predetermined technical standard and then transmits the resulting data. Because the data transmission unallocated region, which is not directly used in normal data transmission, is thus effectively utilized in data transmission, a larger volume of information can be transmitted and received.

### FIELD OF THE INVENTION

The present invention relates to a technology for data transmission and reception between a video/audio transmission device and a video/audio reception to device, more particularly to a high-speed transmission technology compliant with, for example, HDMI (High-Definition Multimedia Interface) Standard.

### BACKGROUND OF THE INVENTION

The entire documents of Japanese patent application No. 2008-262627 filed on Oct. 9, 2008, which include the specification, drawings, and scope of claims, are incorporated herein by reference.

In recent years, the HDMI communication is generally employed in high-speed transmission of video data and audio data from video/audio transmission devices such as DVD (Digital Versatile Disc) player, DVD recording and reproduction device, Blu-ray Disc recording and reproduction device, hard disc recorder, and digital broadcast receiver (set top box) to video/audio reception devices such as TV (television receiver) or projector. The HDMI Standard enables the transmission of audio data and video data through a cable, wherein the audio data is appended to a blanking period of the video data in the form of packet data and then transmitted.

In the case where the video data to be transmitted in the HDMI communication has a poor image resolution, only a limited volume of audio packet data to be transmitted can be appended to the blanking period due to the fact that a pixel clock frequency of any video data having a poor image resolution is inevitably low. As a result, audio packet data having an image quality higher than a certain level cannot be transmitted, and multi-channel transmission, which is rather difficult, cannot be a solution.

A possible approach for the transmission of a high-quality audio data is to double the frequency of the pixel clock frequency by duplicating twice video data of the same pixels. To thus increase the pixel clock frequency, however, raises other issues such as noise increase in the audio data and more power consumption (for example, see the Patent Document 1)

According to the technology disclosed in the Patent Document 2, blank bits of video data are used to transmit the audio packet data in the case where the video data has a poor image resolution. This technique succeeds in transmitting the high-quality audio packet data without increasing the pixel clock frequency.

### PRIOR ART DOCUMENT

### Patent Documents

Patent Document 1: Unexamined Japanese Patent Applications Laid-Open No. 2008-104090
Patent Document 2: Unexamined Japanese Patent Applications Laid-Open No. 2008-118405

### SUMMARY OF THE INVENTION

### Problem to be Solved by the Invention

In any conventional video data, 8 bits are used. In high-bit data (Deep Color), the 8 bits are extended by 2 bits, 4 bits, or 8 bits to 10 bits, 12 bits, or 16 bits, and one of them is used. The Deep Color is obtained by increasing number of colors transferrable through a HDMI terminal, which was incorporated in HDMI 1.3. The necessary bits were thus increased to 10 bits, 12 bits, or 16 bits, because enough number of colors may not be obtained in the conventional 24-bit colors with 8 bits each for RGB or YCbCr. In total, these bits result in 30 bits, 36 bits, and 48 bits, respectively. On a Blu-ray Disc, for example, video data is recorded in 24-bit colors with 8 bits for each color, and the Deep Color is not necessary as far as the data is directly reproduced. However, it may be necessary to use the Deep Color when more colors more than 24 bits are used to create a more vivid image in a reproduction device, or color gradation may be extended to 10 bits in some liquid crystal display devices. Independent of the Deep Color of HDMI, some video data inputted in 8 bits may be displayed in the most suitable colors among 10-bit colors.

The conventional method disclosed in the Patent Document 1, wherein the audio data is appended to the additional bits (2 bits, 4 bits, or 8 bits), is inadequate for the transmission of any Deep Color image, meaning the method fails to transmit the high-quality video data and the Deep Color image at the same time.

The present invention was accomplished to solve the conventional technical problem, and provides a technology for transmitting and receiving data with a higher quality containing a larger information volume than in the prior art independent of an image resolution and data bits of the data to be transmitted.

### Means for Solving the Problem

1) A video/audio transmission device according to the present invention comprises:

a video/audio encoding unit configured to encode an inputted video/audio signal in a format compliant with a predetermined technical standard; and

a differential signal output unit configured to output the encoded data in the form of a differential signal defined by the predetermined technical standard, wherein

the differential signal output unit appends the data encoded by the video/audio encoding unit to a data transmission unallocated region of a communication line defined by the predetermined technical standard and then transmits the resulting data,

the video/audio encoding unit outputs an attribute information indicating whether the encoded data transmitted by using a data transmission region of the communication line defined by the predetermined technical standard for transmitting the data encoded in the format compliant with the predetermined technical standard and the encoded data transmitted by using the data transmission unallocated region of the communication line are both encoded from a signal.

According to the predetermined technical standard recited in the video/audio transmission device, the communication line includes the region allocated for data transmission and the region unallocated for data transmission, and the region unallocated for data transmission is effectively utilized. The video/audio encoding unit encodes the inputted video/audio signal in the format compliant with the predetermined technical standard, and the differential signal output unit divides the encoded data into a plurality of data and then outputs the resulting data in the form of the differential signal compliant with the predetermined technical standard. To output the encoded data, the differential signal output unit outputs the encoded data by using both of the data transmission region and the data transmission unallocated region. Thus, the data transmission unallocated region is effectively utilized. Because the data transmission unallocated region, which is left unused in normal data transmission, is thus effectively utilized, a larger volume of information can be transmitted than in normal data transmission in the format of the predetermined technical standard. This technique is applicable irrespective of the bit extension such as Deep Color. The “unallocated” of “data transmission unallocated region” is a term used by reference to normal data transmission. The present invention is technically characterized in that the unused region is used.

The video/audio encoding unit outputs the attribute information indicating whether the encoded data are encoded from a signal. The attribute information is used by a video/audio reception device on the other end of communication to determine whether the encoded data are decoded as a source signal. This effectuates the effect that data having a larger volume of information can be transmitted regardless of whether the data are originated from a source signal or a plurality of source signals. In the case of audio data, audio data packets encoded from a plurality of sound sources can be separately transmitted through different transmission paths. In the case of video data, video data packets encoded from a plurality of images can be separately transmitted through different transmission paths.

2) In the video/audio transmission device recited in 1), the predetermined technical standard is preferably HDMI Standard. The technical characteristic of 1) is not necessarily limited to HDMI-compliant data but is also applicable to data of other technical standards. According to the technical characteristic of 2), the present invention is preferably applicable to the HDMI Standard. A technical effect obtained by 1) is that a larger volume of information can be transmitted than in normal data transmission in the format of the predetermined technical standard because the data transmission unallocated region, which is left unused in normal data transmission, is effectively utilized. This effect is more apparent when the present invention is applied to the HDMI Standard.

3) In the video/audio transmission device recited in 2), the video/audio encoding unit preferably has a packet generation feature, wherein the differential signal output unit outputs an arbitrary packet data to the data transmission unallocated region. According to the technical characteristic, the present invention is applicable to both of HDMI-compliant data and data compliant with any non-HDMI technical standard because the video/audio encoding unit has the packet generation feature, and the present application is applicable to the transmission of packet data compliant with an arbitrary technical standard as well as the HDMI-compliant data to be transmitted in normal data transmission. Because the data transmission unallocated region, which is left unused in normal data transmission, is thus effectively utilized similarly to the technical characteristic recited in 1), a larger volume of information can be transmitted than in normal data transmission.

4) In the video/audio transmission device recited in 3), the differential signal output unit preferably outputs a packet data defined by the HDMI Standard to the data transmission unallocated region. According to the technical characteristic, the differential signal output unit outputs a packet data defined by the HDMI Standard to the HDMI-compliant data transmission region and then transmits the HDMI packet data, while outputting another packet data defined by the HDMI Standard to the HDMI-compliant data transmission unallocated region to transmit the HDMI packet data. The present invention, wherein a packet data is transmitted by way of the data transmission region while another packet data is transmitted by way of the data transmission unallocated region, is applicable to a plurality of different signals.

5) In the video/audio transmission device recited in 4), the video/audio encoding unit preferably encodes an inputted video signal or audio signal into a packet data defined by the HDMI Standard, and the differential signal output unit separately outputs the encoded packet data to the data transmission unallocated region and the data transmission region defined by the HDMI Standard. According to the technical characteristic, a video signal or an audio signal is encoded into a packet data, and the packet data is divided into a plurality of packet data, so that one of the packet data is outputted to the data transmission region and the other is outputted to the data transmission unallocated region. Thus, the different packet data can be transmitted at the same time so that a larger number of video packet data or audio packet data can be transmitted.

6) In the video/audio transmission device recited in 4), the packet data defined by the HDMI Standard and generated by the video/audio encoding unit is preferably one or at least two of Audio Sample Packet, Audio Clock Regeneration Packet, Audio InfoFrame Packet, One-bit Audio Sample Packet, DST Audio Packet, and HBR Audio Stream Packet. Thus, examples of the audio packet data transmitted by way of the data transmission unallocated region are specifically recited. The Audio Sample Packet is an uncompressed audio packet defined by the HDMI Standard. The Audio Clock Regeneration Packet is a packet transmitted to be used by the reception side to generate an audio clock. The Audio InfoFrame Packet is a packet including parameters representing characteristics of audio data. The One-bit Audio Sample Packet, DST Audio Packet, and HBR Audio Stream Packet are compressed packets defined by the HDMI Standard. According to the technical characteristic, any of these packet data can be transmitted through a plurality of transmission paths to transmit high-quality audio packet data and multi-channel audio packet data, which was infeasible in the prior art.

7) In the video/audio transmission device recited in 4), the packet data defined by the HDMI Standard and outputted by the differential signal output unit is preferably MPEG Source InfoFrame. Thus, an example of the video packet data transmitted by way of the data transmission unallocated region is specifically recited. The MPEG Source InfoFrame is a video packet defined by the HDMI Standard. The technical characteristic can transmit the recited packet data through a plurality of transmission paths, thereby enabling the transmission of high-quality video packet data, which was infeasible in the prior art.

Hereinafter, a video/audio reception device according to the present invention is described.

8) The video/audio reception device according to the present invention comprises:

a differential signal input unit configured to input therein a differential signal defined by a predetermined technical standard;

a video/audio decoding unit configured to decode a data encoded in a format compliant with the predetermined technical standard and transmitted in the form of the differential signal inputted to the differential signal input to obtain a video/audio signal; and

an attribute information determination unit configured to determine based on an inputted attribute information whether data transmitted by using a data transmission region of a communication line defined by the predetermined technical standard for transmitting the data encoded in the format compliant with the predetermined technical standard and the encoded data transmitted by using a data transmission unallocated region of the communication line are both encoded from a signal, wherein

the differential signal input unit inputs therein the encoded data transmitted by using the data transmission region of the communication line defined by the predetermined technical standard for transmitting the data encoded in the format compliant with the predetermined technical standard and the encoded data transmitted by using the data transmission unallocated region of the communication line,

the video/audio decoding unit decodes both of the encoded data inputted to the differential signal input unit by using the data transmission region and the data transmission unallocated region, and

the video/audio decoding unit decodes the encoded data after combining the encoded data in the form of a signal when a result of the determination by the attribute information determination unit is affirmative.

According to the technical characteristic, the encoded data compliant with the predetermined technical standard transmitted from the video/audio transmission device on the other end of communication is inputted to the differential signal input unit and then given to the video/audio decoding unit. The video/audio decoding unit decodes both of the encoded data by way of the data transmission region and the encoded data by way of the data transmission unallocated region, so that the data included in the data transmission unallocated region, if any, can be received. As a result, a larger volume of information can be received than in normal data reception in the format of the predetermined technical standard.

Further, the differential signal compliant with the predetermined technical standard transmitted from the video/audio transmission device on the other end of communication is inputted to the differential signal input unit and then given to the video/audio decoding unit. The attribute information determination unit determines based on the attribute information whether the encoded data by way of the data transmission region and the encoded data by way of the data transmission unallocated region are encoded from a signal. When the determination result is affirmative, the video/audio decoding unit decodes the encoded data after combining them in the form of a signal. When the determination result is negative, the video/audio decoding unit decodes the encoded data separately as different signals.

When the encoded data generated from a signal source are transmitted by using the data transmission region and the data transmission unallocated region separately, the data can be combined into one data and then decoded. As a result, a larger volume of information can be received than in normal data reception in the format of the predetermined technical standard, and multi-channel data can also be transmitted and received.

9) In the video/audio reception device recited in 8), the predetermined technical standard is preferably HDMI Standard. The technical characteristic of 8) is not necessarily limited to HDMI-compliant data but is also applicable to data of other technical standards. According to the technical characteristic of 9), the present invention is preferably applicable to the HDMI Standard. A technical effect obtained by 9) is that a larger volume of information can be received than in normal data reception in the format of the predetermined technical standard because the data transmission unallocated region, which is left unused in normal data transmission, is effectively utilized. This effect is more apparent when the present invention is applied to the HDMI Standard.

10) In the video/audio reception device recited in 9), in the case where an arbitrary packet data is included in the data transmission unallocated region, the video/audio decoding unit preferably decodes the arbitrary packet data. According to the technical characteristic, the present invention is applicable to both of HDMI-compliant data and data compliant with any non-HDMI technical standard, and the present application is applicable to the reception of packet data compliant with an arbitrary technical standard as well as the HDMI-compliant data to be transmitted in normal data transmission. Because the data transmission unallocated region, which is left unused in normal data transmission, is thus effectively utilized similarly to the technical characteristic recited in 8), a larger volume of information can be received than in normal data reception.

11) In the video/audio reception device recited in 10), in the case where an audio packet data defined by the HDMI Standard is included in the data transmission unallocated region, the video/audio decoding unit preferably decodes the audio packet data into an audio signal. According to the technical characteristic, the HDMI audio packet data to be received in normal data reception can be decoded by way of the data transmission region compliant with the HDMI Standard, while another packet data compliant with a non-HDMI technical standard can be decoded by way of the data transmission unallocated region. A packet data is decoded by way of the data transmission region, while another packet data is decoded by way of the data transmission unallocated region, meaning that the present invention is applicable to a plurality of different signals. Thus, the present invention can obtain a plurality of different audio signals by separately decoding the audio packets transmitted through to more than one path into different audio signals.

12) In the video/audio reception device recited in 10), in the case where a video packet data defined by the HDMI Standard is included in the data transmission unallocated region, the video/audio decoding unit preferably decodes the video packet data into a video signal. According to the technical characteristic, while the HDMI video packet data to be received in normal data reception can be received, another packet data can be received as well. Thus, the present invention can obtain a plurality of different video signals by separately decoding the video packets transmitted through more than one path into different video signals.

13) In the video/audio reception device recited in 8), the video/audio decoding unit preferably decodes audio packet data respectively transmitted by using the data transmission unallocated region and the data transmission region defined by the HDMI Standard after combining the audio packet data into an audio signal. According to the technical characteristic, the audio packets transmitted through a plurality of paths can be combined into an audio signal with a higher quality and then decoded.

14) In the video/audio reception device recited in 8), the video/audio decoding unit preferably decodes video packet data respectively transmitted by using the data transmission unallocated region and the data transmission region defined by the HDMI Standard after combining the video packet data into a video signal. According to the technical characteristic, the video packets transmitted through a plurality of paths can be combined into a video signal with a higher quality and then decoded.

15) In the video/audio transmission device recited in 1), the attribute information preferably includes an information indicating whether there is any data in the data transmission unallocated region. According to the technical characteristic, it can be determined whether the packet data respectively transmitted by using the data transmission unallocated region and the data transmission region defined by the predetermined technical standard are different packet data respectively encoded from different inputted signals or packet data encoded from an inputted signal and then divided to be transmitted.

16) In the video/audio reception device recited in 8), the attribute information determination unit preferably determines whether there is any data in the data transmission unallocated region. According to the technical characteristic, it can be determined whether the packet data received by using the data transmission unallocated region and the data transmission region defined by the predetermined technical standard are different packet data respectively encoded from different inputted signals or a packet data encoded from an inputted signal and then divided to be received. Depending on the determination result, the packet data is suitably decoded to generate signals.

### Effect of the Invention

According to the present invention wherein the data transmission unallocated region, which is normally left unused in the predetermined technical standard, is thus effectively utilized, a larger volume of information can be transmitted and received than in normal data transmission in the format of the predetermined technical standard.

### BRIEF DESCRIPTION OF THE DRAWINGS

FIG. 1 is a block diagram illustrating a connection configuration between a video/audio transmission device and a video/audio reception device according to an exemplary embodiment 1 of the present invention.

FIG. 2 is a conceptual illustration of a data transmission region and a data transmission unallocated region in packet transmission defined by HDMI Standard (prior art).

FIG. 3 is a conceptual illustration of a data transmission region and a data transmission unallocated region in packet transmission according to the present invention.

FIG. 4 is a conceptual illustration of a data transmission region and a data transmission unallocated region in packet transmission according to the exemplary embodiment 1.

FIG. 5 is a block diagram illustrating a connection configuration between a video/audio transmission device and a video/audio reception device according to an exemplary embodiment 2 of the present invention.

FIG. 6A illustrates an example of data provided by attribution information.

FIG. 6B illustrates a data determination flow of the video/audio reception device in which the data of attribute information is used.

FIG. 7 illustrates a 3D video format defined by HDMI Ver1.4.

FIG. 8 is a block diagram illustrating a connection configuration between a video/audio transmission device and a video/audio reception device according to an exemplary embodiment 3 of the present invention.

FIG. 9A illustrates an example of data provided by attribution information.

FIG. 9B illustrates a data determination flow of the video/audio reception device in which the data of attribute information is used.

FIG. 10 is a block diagram illustrating a connection configuration between a video/audio transmission device and a video/audio reception device according to an exemplary embodiment 4 of the present invention.

FIG. 11 is a conceptual illustration of a data transmission region and a data transmission unallocated region in packet transmission according to the exemplary embodiment 4.

FIG. 12A illustrates an example of data provided by attribution information.

FIG. 12B illustrates a data determination flow of the video/audio reception device in which the data of attribute information is used.

### EXEMPLARY EMBODIMENTS FOR CARRYING OUT THE INVENTION

### Exemplary Embodiment 1

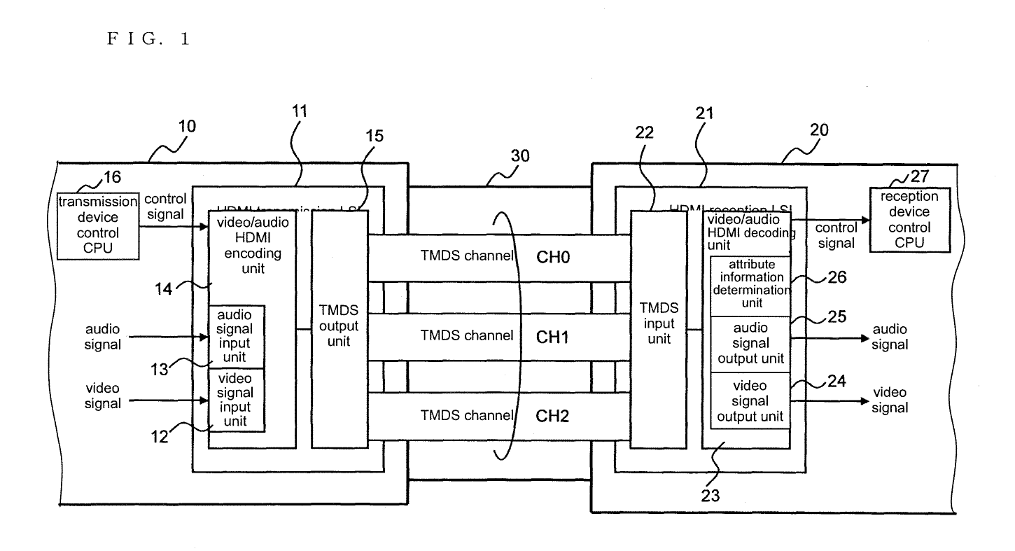

FIG. 1 is a block diagram illustrating a connection configuration between a video/audio transmission device and a video/audio reception device according to an exemplary embodiment 1 of the present invention. Describing reference numerals illustrated in FIG. 1, 10 is a DVD player which is an example of the video/audio transmission device, 20 is a TV which is an example of the video/audio reception device, and 30 is an HDMI cable. The DVD player 10 and the TV 20 are connected to each other by the HDMI cable 30.

A structural characteristic of the DVD player 10 is specifically described. The DVD player 10 comprises a video/audio reproduction unit (not illustrated in the drawing) to read video and audio signals from a recording medium, DVD. The DVD player 10 comprises an HDMI transmission LSI 11, a video signal input unit 12 to which a video signal reproduced by the video/audio reproduction unit is inputted, an audio signal input unit 13 to which an audio signal reproduced by the video/audio reproduction unit is inputted, a video/audio HDMI encoding unit 14 which is a video/audio encoding unit having a packet generation feature in addition to a feature of encoding inputted video and audio signals in a HDMI format, a TMDS output unit 15 which is a differential signal output unit configured to output HDMI signals inputted from the video/audio HDMI encoding unit 14 using three TMDS channels CH0, CH1, and CH2 to the HDMI cable 30 in the form of different signals, and a transmission device control CPU in charge of controlling the DVD player 10. The transmission through the HDMI cable 30 uses these three TMDS channels CH0, CH1, and CH2.

The TMDS is an abbreviation for “Transition Minimized Differential Signaling”, which is a digital signal transmission method used for data communication between such devices as a personal computer, a tuner, a television and a display. The TMDS, in which differential signals are used, is capable of a better tolerance for noise and signal distortion.

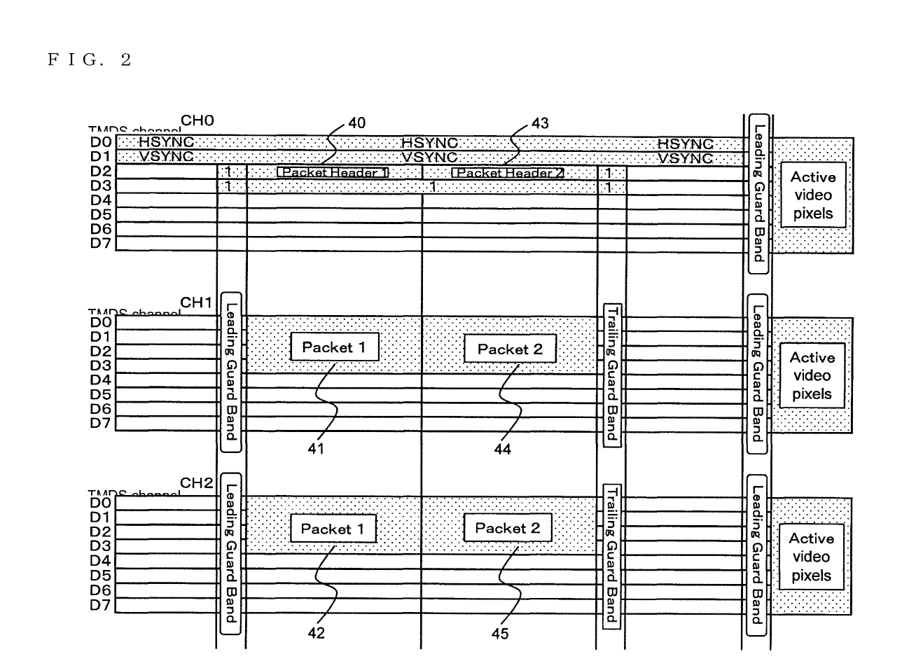

FIG. 2 is a conceptual illustration of a data transmission region and a data transmission unallocated region in packet transmission defined by the HDMI Standard according to the prior art. In FIG. 2, hatched parts are normal data transmission regions defined by the HDMI Standard, and unhatched parts in data lines D4-D7 below Packet 1 and Packet 2 are regions unallocated for data transmission. According to the HDMI Standard, audio signals transmitted by using the TMDS channels are transmitted in a part of a video blanking period in the form of packet data 40-42 and packet data 43-45. HSYNC denotes a horizontal synchronous signal, and VSYNC denotes a vertical synchronous signal. D0-D7 denote 8-bit data lines. The video data is transmitted during a video period by using all of the eight data lines D0-D7, whereas the audio data is transmitted during a blanking period by using only four of the data lines, D0-D3, in normal transmission. In the drawing, two audio packet data are transmitted (Packet 1, Packet 2). A synchronous signal and an audio packet header are transmitted in the TMDS channel CH0 in the form of a packet data 40, transmitted in the TMDS channel CH1 in the form of an audio packet data 41, and transmitted in the TMDS channel in the form of an audio packet data 42. By a different timing, the synchronous signal and the audio packet header are transmitted in the TMDS channel CH0 in the form of a packet data 43, transmitted in the TMDS channel CH1 in the form of an audio packet data 44, and transmitted in the TMDS channel CH2 in the form of an audio packet data 45.

In FIG. 2 illustrating the prior art, only the data lines D0-D3 of the TMDS channels CH0-CH2 are used in the transmission of the audio data, which are the packet data 40-45, while the data lines D4-D7 are unallocated for data transmission.

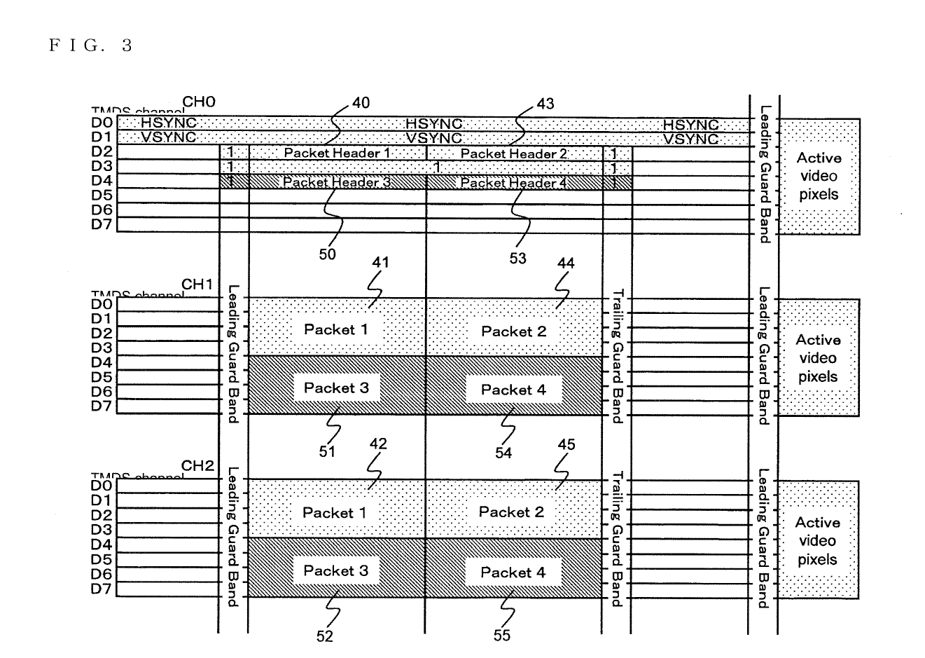

In contrast, the present invention is technically advantageous in that the data lines D4-D7 normally unallocated for data transmission in the HDMI Standard are effectively utilized. As illustrated in FIG. 3, HDMI packet data are transmitted to data transmission unallocated regions 50-52 and (or) data transmission unallocated regions 53-55 (see the hatched sections). The “unallocated” of “data transmission unallocated region” is a term used by reference to normal data transmission.

In the data transmission using the TMDS channel CH0, the audio packet data is appended to the data transmission unallocated region 50 and then transmitted. In the data transmission using the TMDS channel CH1, the audio packet data is appended to the data transmission unallocated region 51 and then transmitted. In the data transmission using the TMDS channel CH2, the audio packet data is appended to the data transmission unallocated region 52 and then transmitted (Packet 3). By a different timing, the audio packet data is appended to the data transmission unallocated region 53 and then transmitted in the TMDS channel CH4, the audio packet data is appended to the data transmission unallocated region 54 and then transmitted in the TMDS channel CH5, and the audio packet data is appended to the data transmission unallocated region 55 and then transmitted in the TMDS channel CH5 (Packet 4).

Referring to FIG. 1, the video/audio HDMI encoding unit 14 is configured to generate and output an attribute information indicating whether there is any packet data present in the data transmission unallocated regions of a communication line defined by the HDMI Standard. The TMDS output unit 15 is configured to append the attribute information to the data transmission unallocated region and then transmit the resulting data to the HDMI cable 30.

A structural characteristic of the TV 20 is specifically described below. The TV 20 comprises an HDMI reception LSI 21, a TMDS input unit 22 which is a differential signal input unit configured to receive HDMI signals transmitted from the DVD player 10 by way of three TMDS channels CH0 CH1, and CH2, a video/audio HDMI decoding unit 23 which is a video/audio HDMI decoding unit configured to decode video and audio signals from the inputted HDMI signals, a video signal output unit 24 configured to output the decoded video signal, an audio signal output unit 25 configured to output the decoded audio signal, and an attribute information determination unit 26 configured to check the attribute information in the data transmission unallocated regions. The attribute information determination unit 26 determines based on a value of the attribute information whether the packet data is present in any of the data transmission unallocated regions defined by the HDMI Standard. The TV 20 further comprises a reception device control CPU 27 in charge of controlling the TV 20.

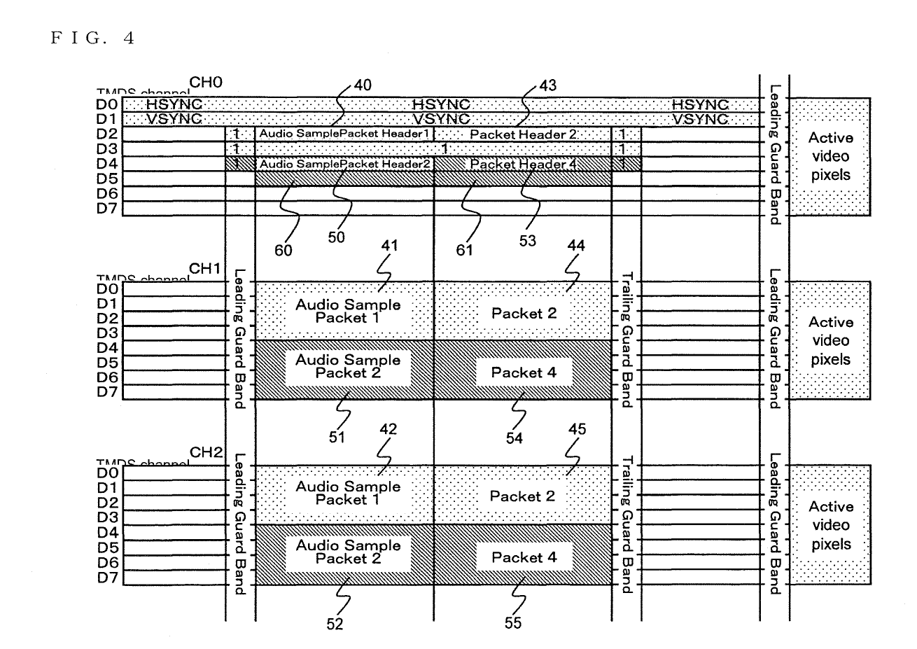

Hereinafter are described operations of the video/audio transmission device and the video/audio reception device according to the present exemplary embodiment thus structurally characterized referring to a specific example illustrated in FIG. 4. First, the operation of the DVD player 10 is described. The video/audio reproduction unit not illustrated in the drawing reads the video and audio signals from the recording medium (DVD). The read video signal is inputted to the video signal input unit 12, and the read audio signal is inputted to the audio signal input unit 13. The encoding unit 14 converts the video signal transmitted from the video signal input unit 12 into an HDMI signal and outputs the HDMI signal to the TMDS output unit 15. Similarly, the encoding unit 14 converts the audio signal transmitted from the audio signal input unit 13 into an HDMI signal and outputs the HDMI signal to the TMDS output unit 15. The HDMI signals inputted to the TMDS output unit 15 are respectively divided into three differential signals for the TMDS channels CH0, CH1, and CH2 and then outputted to the HDMI cable 30.

The encoding unit 14 has a packet generation feature to generate a control-drive packet including the attribute information based on a control-drive signal inputted from the transmission device control CPU 16 and output the generated signal to the TMDS output unit 15. The attribute information generated by the encoding unit 14 in this description indicates that the packet data is present in any of the data transmission unallocated regions. To transmit the attribute information, the TMDS output unit 15 appends the attribute information to a data transmission unallocated region 60. When the attribute is thus transmitted, the attribute information determination unit 26 of the TV 20 can determine that the packet data present in the data transmission unallocated region should also be decoded. The data transmission unallocated region 60 is chosen as the region to which the attribute information is appended, however, the attribute information may be appended to any of the data transmission unallocated regions of the TMDS channel CH0. A similarly configured attribute information may be appended to a reserved region of Audio Sample Packet defined by the HDMI Standard. The attribute information inputted to the TMDS output unit 15 is outputted to the HDMI cable 30 by way of the TMDS channel CH0.

In the example illustrated in FIG. 4, the encoding unit 14 converts the audio signals inputted from the audio signal input unit 13 into audio sample packets, and separately transmits the sample packets to the data transmission unallocated regions 50-52 and the data transmission regions 40-42 defined by the HDMI Standard of the TMDS channels CH0, CH1, and CH3. As a result, a volume of audio sample packets transmitted per unit time can be doubled as compared to the prior art. Further, the data transmission unallocated regions 53-55 can be used as well to transmit the audio sample packets, which further increases the volume of packet data that can be transmitted.

Next, the operation of the TV 20 is described. The TMDS input unit 22 receives the HDMI signals transmitted from the DVD player 10 by way of the TMDS channels CH0, CH1, and CH2 of the HDMI cable 30. The TMDS input unit 22 receives the audio sample packets transmitted by using the data transmission regions 40-42 and the audio sample packets transmitted by using the data transmission unallocated regions 50-52.

The video packet inputted to the TMDS input unit 22 is decoded as a video signal by the video/audio HDMI decoding unit 23. The audio sample packet inputted to the TMDS input unit 22 is decoded as an audio signal by the decoding unit 23. The attribute information of the data transmission unallocated region 60 is checked by the attribute information determination unit 26 to confirm whether the audio sample packet is present in any of the data transmission unallocated regions 50-52. As a result of the confirmation, not only the audio sample packets of the data transmission regions but also the audio sample packets of the data transmission unallocated regions are decoded.

As described so far, the video/audio transmission device according to the present exemplary embodiment (DVD player 10) effectively utilizes the data transmission unallocated regions which are conventionally not directly used in normal data transmission in the HDMI Standard, thereby increasing a volume of audio sample packets transmitted per unit time as compared to the prior art. According to the technical advantage thus provided, any audio data with a high quality, which conventionally could not be transmitted due to pixel clock restrictions, can be successfully transmitted, and the video/audio reception device (TV 20) can convert the audio data transmitted from the video/audio transmission device into a high quality audio signal which was conventionally infeasible, and then reproduce such a high quality audio signal. As a result, when the video/audio reception device and the video/audio transmission device are connected to each other, a distinctly advantageous reproduction system can be provided capable of outputting any high quality audio data which conventionally could not be reproduced.

Though the uncompressed audio packets are so far described, the present exemplary embodiment is applicable to One-bit Audio Sample Packet, DST Audio Packet, and HBR Audio Stream Packet as well.

Though the description was given so far based on the audio packets, the present exemplary embodiment is applicable to MPEG Source InforFrame which is a video packet defined by the HDMI Standard.

The present exemplary embodiment is applicable to all kinds of packets defined by the HDMI Standard. The control-drive packet defined by the HDMI Standard is converted by the decoding unit 23 into a control-drive signal and transmitted to the reception device control CPU 27.

Further, the present exemplary embodiment is not necessarily limited to the transmission/reception of HDMI packets but can be applied to the transmission/reception of any other independent data.

The exemplary embodiment 1 can be applied to data in which Deep Color is used.

### Exemplary Embodiment 2

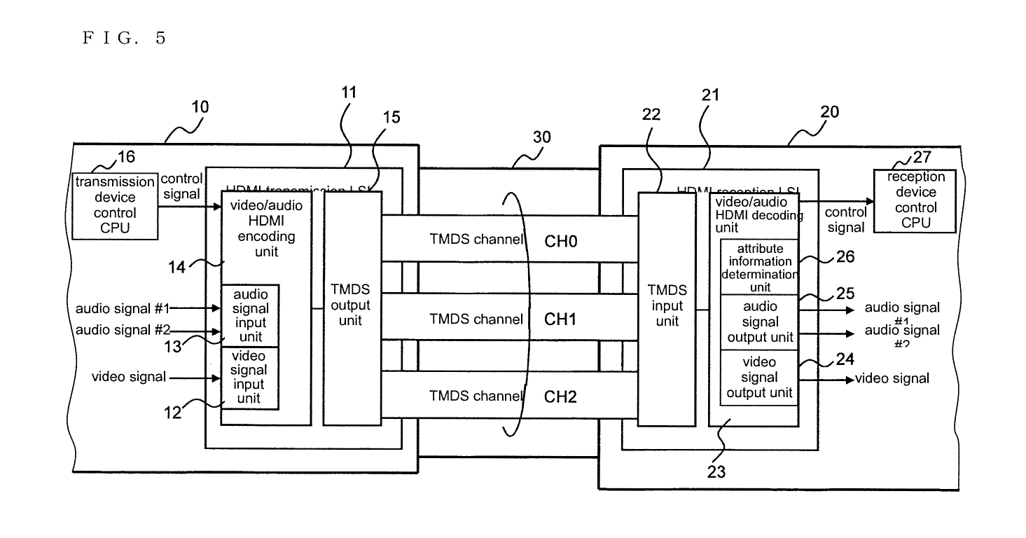

FIG. 5 is a block diagram illustrating a connection configuration between a video/audio transmission device and a video/audio reception device according to an exemplary embodiment 2 of the present invention. The same reference numerals illustrated in FIG. 5 as those illustrated in FIG. 1 according to exemplary embodiment 1 all indicate the same structural elements. The present exemplary embodiment is technically unique as described below.

The audio signal input unit 13 of the DVD player 10 has two different inputs through which audio signals #1 and #2 are inputted. The audio signal output unit 25 of the TV 20 has two different outputs through which audio signals #1 and #2 are outputted.

The audio signals #1 and #2 respectively inputted to the audio signal input unit 13 are converted into separate audio sample packets by the video/audio HDMI encoding unit 14. Further, Audio Clock Regeneration Packet, and Audio InfoFrame Packet are also generated from the audio signals, respectively. The audio clock regeneration packet is transmitted to be used by the TV 20 to generate an audio clock. The audio infoframe packet includes parameters representing characteristics of audio data. An audio signal is generated from these three packets.

According to the present exemplary embodiment, the encoding unit 14 of the DVD player 10 is configured to generate and output an attribute information indicating whether packet headers and packet data transmitted by using the data transmission regions 40-42 for transmitting the data in the format defined by the HDMI standard and the data transmission unallocated regions 50-52 of the communication defined by the HDMI Standard line are both encoded from a signal (see the data transmission unallocated region 60 illustrated in FIG. 4).

The attribute information determination unit 26 of the TV 20 is configured to confirm based on a value of the received attribute information whether the audio sample packets transmitted by using the data transmission unallocated regions 50-52 and the data transmission regions 40-42 defined the HDMI Standard are both converted from an audio source.

The encoding unit 14 divides the three different audio data packets generated from the audio signal #1 and the audio signal #2 respectively into two packet data. The TMDS output unit 15 transmits one of the packet data by using the HDMI-compliant data transmission regions 40-42, while transmitting the other packet data by using the data transmission unallocated regions 50-52. Accordingly, the packet data of the two different audio signals #1 and #2 inputted through two inputs can be transmitted at the same time to the TV 20 via the HDMI cable 30. When the audio signals are thus transmitted, the encoding unit 14 generates and transmits an information notifying that the different data are separately transmitted as the attribute information. The transmission of the attribute information allows the attribute information determination unit 26 of the TV 20 to determine whether the audio sample packets should be separately decoded or collectively decoded.

In the TV 20, the video packet from the TMDS input unit 22 is decoded as a video signal by the video/audio HDMI decoding unit 23, and the audio sample packet from the TMDS input unit 22 is decoded as an audio signal by the decoding unit 23. The attribute information of the data transmission unallocated region 60 is checked by the attribute information determination unit 26 to determine whether the audio sample packets transmitted by using the data transmission unallocated regions 50-52 and the data transmission regions 40-42 defined the HDMI Standard are both converted from an audio source. When the attribute information determination unit 26 confirmed that the two audio sample packets are originated from different audio sources, the audio sample packets are decoded as separate audio signals. When the attribute information determination unit 26 confirmed that the two audio sample packets are originated from the same audio source, the audio sample packets are combined into an audio signal and then decoded.

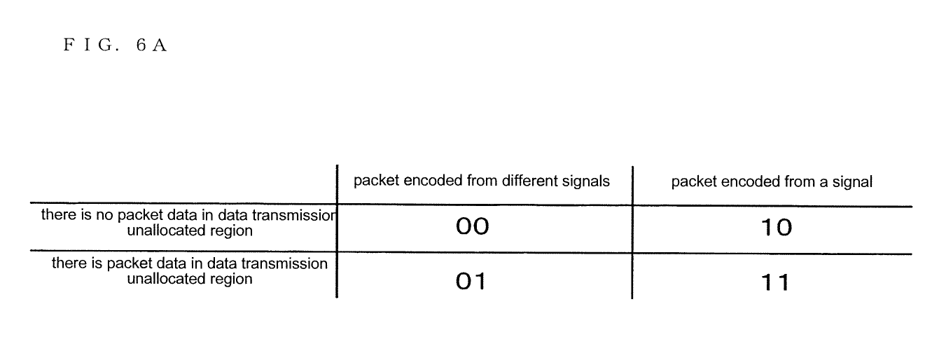

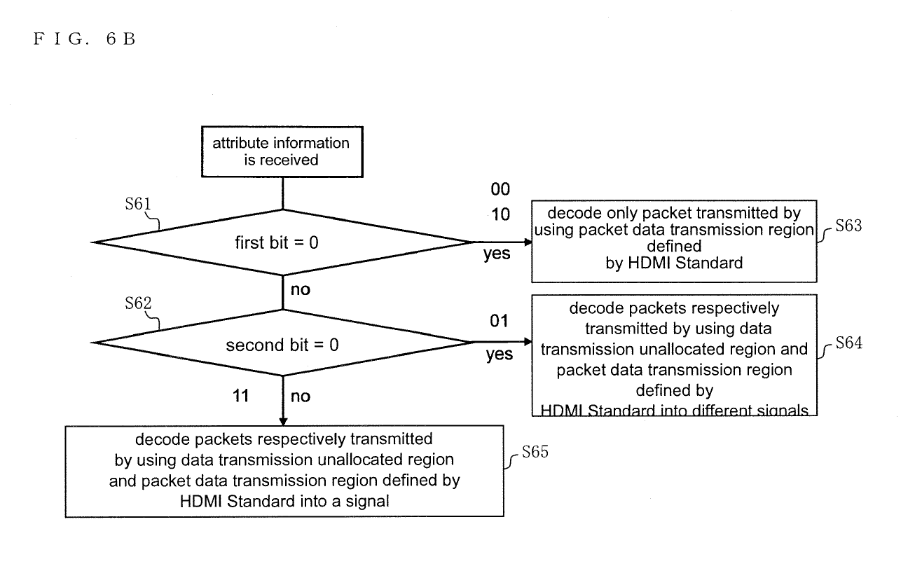

A specific example of the attribute information is described referring to FIG. 6A. In the illustrated example of the attribute information, a pair of confirmations, whether the packet data is present in any of the data transmission unallocated regions and whether the two packet data are originated from different signals or a signal, constitutes the attribute information.

It is confirmed in the first bit of the attribute information whether the packet data is present in any of the data transmission unallocated regions. The first bit is “1” with no packet data, while the first bit is “0” with the packet data present in the region.

It is confirmed in the second bit of the attribute information whether the two packet data are originated from different signals or a signal. The second bit is “0” in the case of the two packet data originated from different signals, while the second bit is “1” in the case of the two packet data originated from a signal.

The attribute information is determined by the attribute information determination unit 26 in accordance with a flow chart illustrated in FIG. 6B. When the attribute information is received, the first bit is checked (Step S61), and the second bit is checked (Step S62). When the first bit=0 (“00” and “10”) is known by checking the first bit (Step S61), only the packet data transmitted by way of the HDMI-compliant data transmission region is decoded (Step S63). When the first bit=1 (“01” and “11”) is known by checking the first bit (Step S61), the second bit is checked Step S62). When the second bit=0 (“01”) is known by checking the second bit (Step S62), the packet data transmitted by way of the HDMI-compliant data transmission region and the packet data transmitted by way of the data transmission unallocated region are decoded as separate signals (Step S64). When the second bit=1 (“11”) is known by checking the second bit (Step S62), the packet data transmitted by way of the HDMI-compliant data transmission region and the packet data transmitted by way of the data transmission unallocated region are decoded as a signal (Step S65).

This specification omits description of the rest of the operation and configuration according to the present exemplary embodiment which are similar to those of the exemplary embodiment 1. The parenthetical references of the exemplary embodiment 1 are also applicable to the present exemplary embodiment.

As described so far, the present exemplary embodiment is technically advantageous in that the two audio signals generated by the video/audio transmission device (DVD player 10) can be transmitted to the video/audio reception device (TV 20), and the video/audio reception device can convert the audio data packet transmitted from the video/audio transmission device into two audio signals, so that the different audio signals can be outputted.

### Exemplary Embodiment 3

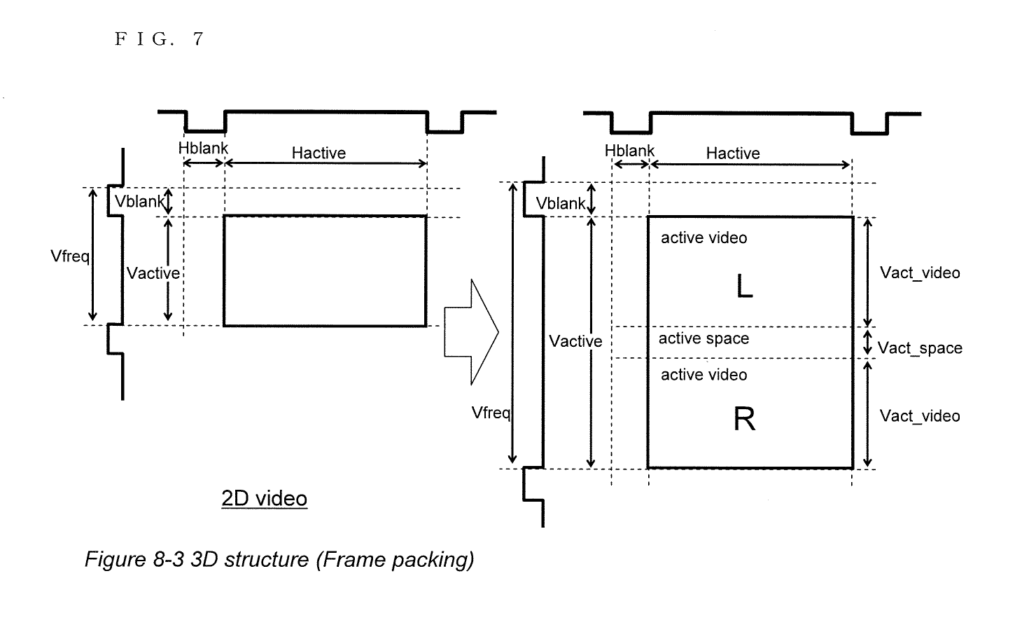

FIG. 7 illustrates a 3D video format defined by HDMI Ver1.4. The video format can transmit an image for left eye and an image for right eye. The present exemplary embodiment was developed for transmitting the 3D video format, wherein the technique according to the present invention is applied to the transmission and reception of two different images at the same time on the condition that the image for left eye and the image for right eye are totally different images.

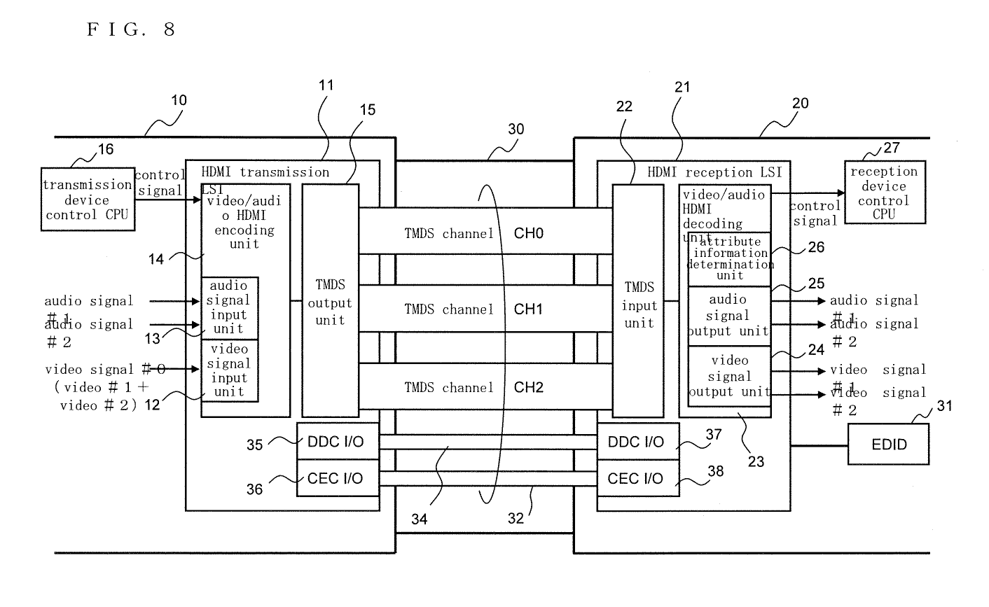

FIG. 8 is a block diagram illustrating a connection configuration between a video/audio transmission device and a video/audio reception device according to an exemplary embodiment 3 of the present invention. The same reference numerals illustrated in FIG. 8 as those illustrated in FIG. 5 according to exemplary embodiment 2 all indicate the same structural elements. The present exemplary embodiment is technically unique as described below.

In the DVD player 10, a 3D video format video signal #0, in which the image for left eye (image #1) and the image for right eye (image #2) are totally different images, is inputted to the video signal input unit 12. The video signal output unit 24 of the TV 20 has two different outputs through which video signals #1 and #2 are outputted. The audio signal #1 is paired with the image #1 (video signal #1), and the audio signal #1 is paired with the image #1 (video signal #2).

According to the present exemplary embodiment, the audio signals #1 and #2 inputted to the audio signal input unit 13 of the DVD player 10 are converted into different audio sample packets, and the audio clock regeneration packet and audio infoframe packet are generated therefrom similarly to the exemplary embodiment 2. The resulting packets are transmitted to the TV 20.

Similarly to the exemplary embodiment 2, the encoding unit 14 divides the three different audio data packets generated from the audio signals #1 and #2 into two audio packet data, and the TMDS output unit 15 outputs one of the packet data to the data transmission regions 40-42 (FIG. 4) defined by the HDMI Standard, while transmitting the other packet data to the data transmission unallocated regions 50-52 (FIG. 4).

The encoding unit 14 is further configured to transmit an information indicating that the image #1 and the image #2 are configured in 3D video formats totally different to each other, and an attribute information used to determine which of the packet data generated from the audio signal #1 and the packet data generated from the audio signal #2 is transmitted by using the HDMI-compliant data transmission regions 40-42 (FIG. 4) and which of the packet data is transmitted by using the data transmission unallocated regions 50-52 (FIG. 4) using the data transmission unallocated regions 60 and 61 (FIG. 4) similarly to the exemplary embodiment 2.

The DVD player 10 has to determine before the transmission whether the TV 20 can receive the 3D video format data (containing the images #1 and #2 totally different to each other) transmitted in the present exemplary embodiment. There are two ways for the DVD player 10 to determine whether the formats can be received as described below.

One of them is to recite an information that the video signals transmitted in the present exemplary embodiment can be received in an EDID (Extended Display Identification Data) 31 which is a reception device information, so that the DVD player 10 can determine whether the video signals can be received by reading the EDID of the TV 20. The HDMI transmission LSI 11 and the HDMI reception LSI 21 respectively comprise an interface 35 and an interface 37 for DDC (Display Data Channel) communication. The DVD player 10 can read the information of the EDID 31 provided in the TV 20 by way of a DDI line 34 which is a part of the HDMI cable 30.

The other is for the DVD player 10 to obtain an information on whether the video signals transmitted from the TV 20 according to the present exemplary embodiment can be received by communicating with the TV 20 through a CEC (Consumer Electronics Control) 32. The HDMI transmission LSI 11 and the HDMI reception LSI 21 respectively comprise an interface 36 and an interface 38 for CEC communication. The DVD player 10 and the TV 20 can transmit and receive information to and from each other through a CEC line 34 which is a part of the HDMI cable 30.

In either way, it is confirmed whether the TV 20 can receive the 3D video format data (containing the images #1 and #2 totally different to each other). After the confirmation, the DVD player 10 starts to transmit the images.

Based on the attribute information transmitted from the DVD player 10, the followings are determined by the attribute information determination unit 26 of the TV 20:
whether the conventional 3D video format or the 3D video format containing the images #1 and #2 totally different to each other; and
whether the packet data transmitted by using the HDMI-compliant data transmission regions 40-42 or the packet data transmitted by using the data transmission unallocated regions 50-52.

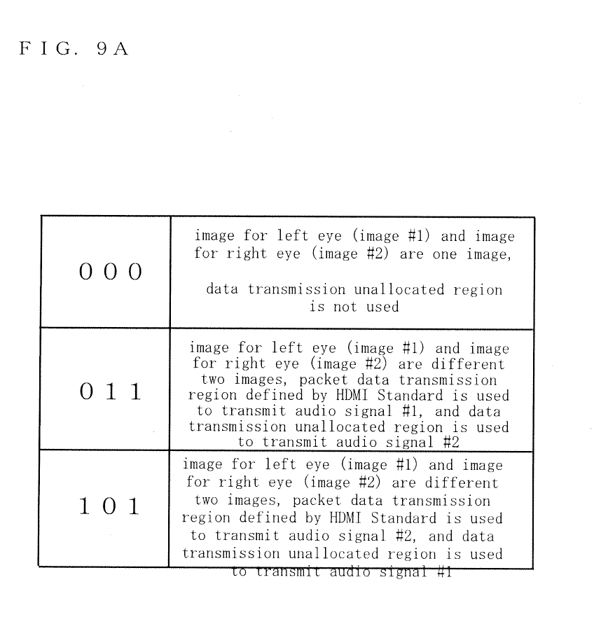

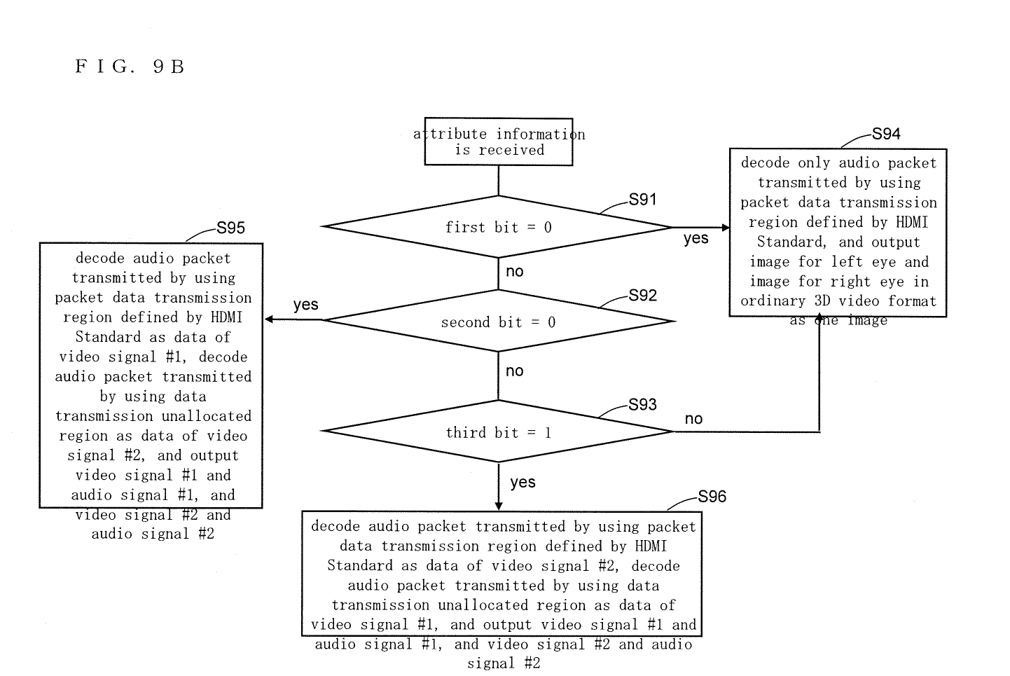

Examples of the attribute information are described referring to FIG. 9A The drawing illustrates the following three examples.

First, the attribute information takes the value of “000” in the case where there is one image as the image #1 and the image #2 (no packet data in the data transmission unallocated region).

Second, the attribute information takes the value of “011” in the case where the images #1 and #2 are two different images, and the packet data of the image #1 is transmitted by way of the HDMI-compliant data transmission region, while the packet data of the image #2 is transmitted by way of the data transmission unallocated region.

Third, the attribute information takes the value of “101” in the case where the images #1 and #2 are two different images, and the packet data of the image #2 is transmitted by way of the HDMI-compliant data transmission region, while the packet data of the image #1 is transmitted by way of the data transmission unallocated region.

The attribute information is determined by the attribute information determination unit 26 in accordance with a flow chart illustrated in FIG. 9B. When the attribute information is received, the first bit is checked (Step S91), the second bit is checked (Step S92), and the third bit is checked (Step S93). In this description, a lower bit is called the first bit. When the first bit=0 is known by checking the first bit (Step S91), only the packet data transmitted by using the HDMI-compliant data transmission region is decoded, and the image for left eye and the image for right eye are paired and outputted as an image in the conventional 3D video format (Step S94). When the first bit=1 is known, the second bit is checked next (Step S92). When the second bit=1 is known by checking the second bit (Step S92), the audio packet data transmitted by using the HDMI-compliant data transmission region is decoded as the data of the video signal #1, and the audio packet data transmitted by using the data transmission unallocated region is decoded as the data of the video signal #2 (Step S95). When the second bit=0 is known by checking the second bit (Step S92), the third bit is checked (Step S93). When the third bit=1 is known by checking the third bit (Step S93), the audio packet data transmitted by using the HDMI-compliant data transmission region is decoded as the data of the video signal #2, and the audio packet data transmitted by using the data transmission unallocated region is decoded as the data of the video signal #1 (Step S96). When the third bit=0 is known by checking the third bit (Step S93), the same process as the first bit=0 (Step S94) is carried out.

As described so far, the video/audio transmission device according to the present exemplary embodiment (DVD player 10) is technically advantageous in that the 3D video format configured such that the images for left eye and right eye are totally different images is used, and one of the audio packet data is transmitted by using the data transmission unallocated region, so that the video/audio reception device (TV 20) can separately output the two video/audio signals at the same time.

### Exemplary Embodiment 4

Similarly to the exemplary embodiment 3, an exemplary embodiment 4 of the present invention was developed for the transmission of the 3D video format, wherein the technique according to the present invention is applied to the transmission and reception of two different images at the same time on the condition that the image for left eye and the image for right eye are totally different images.

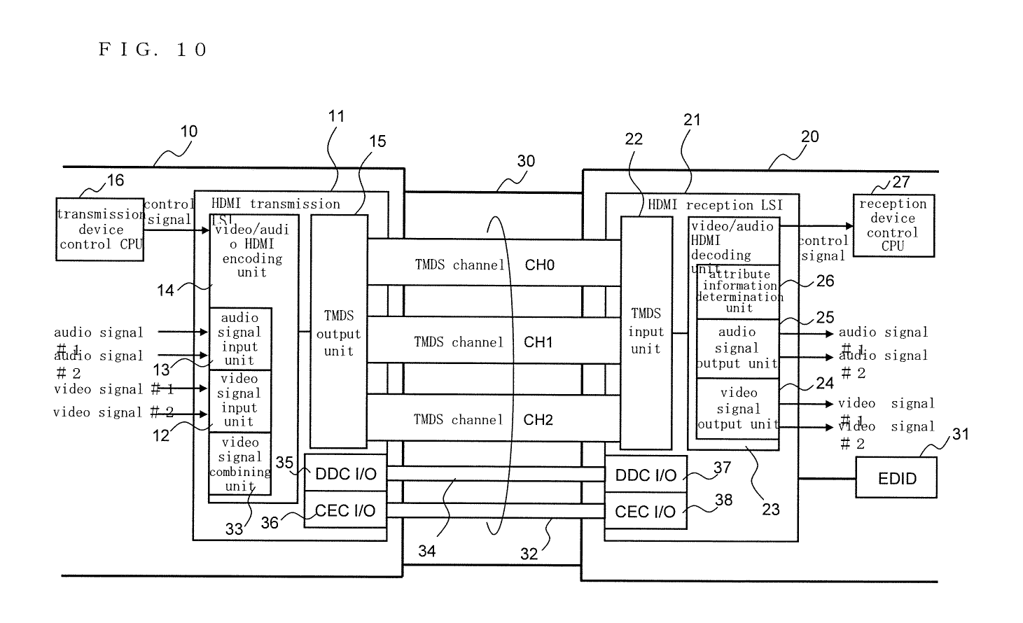

FIG. 10 is a block diagram illustrating a connection configuration between a video/audio transmission device and a video/audio reception device according to the exemplary embodiment 4. The same reference numerals illustrated in FIG. 10 as those illustrated in FIG. 8 according to exemplary embodiment 3 all indicate the same structural elements. The present exemplary embodiment is technically unique as described below.

The video signal input unit 12 of the DVD player 10 has two different inputs through which video signals #1 and #2 are inputted, and a video signal combining unit 33 which combines the video signals #1 and #2. The TV 20 is configured similarly to the exemplary embodiment 3.

The video signals #1 and #2 inputted to the video signal input unit 12 are converted by the video signal combining unit 33 so that the video signal #1 and the video signal #2 are respectively used as a left-eye image L and a right-eye image R according to the technical standard illustrated in FIG. 7.

The encoding unit 14 is equipped with a packet generation feature. All of the packet data generated from the audio signal #1 and the video signal #1 by the encoding unit 14 are collectively called a packet #1, and all of the packet data generated from the audio signal #2 and the video signal #2 by the encoding unit 14 are collectively called a packet #2. The packets #1 and #2 include all of the packets defined by the HDMI Standard.

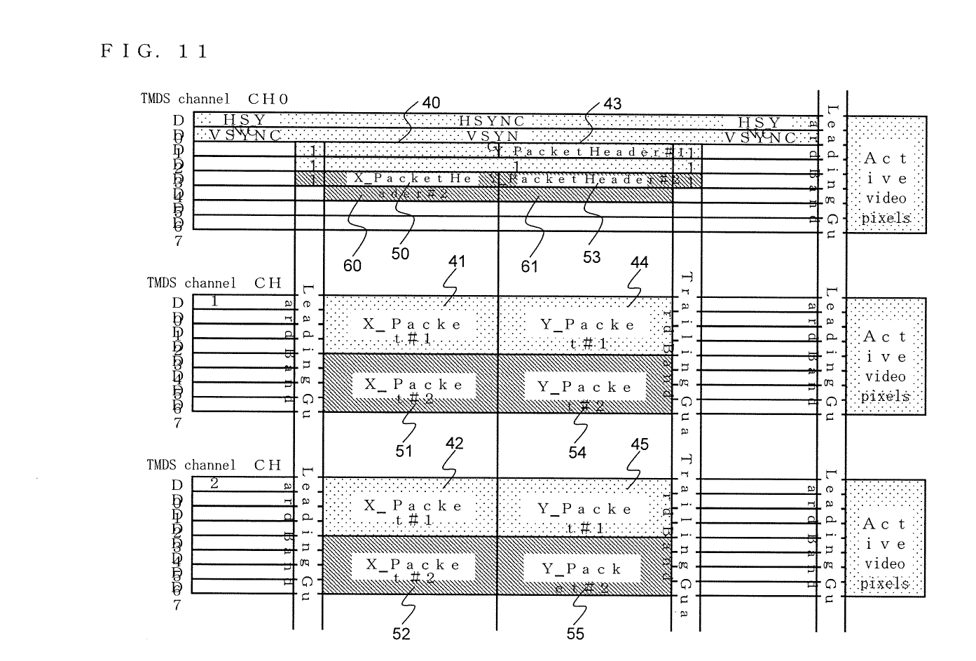

As illustrated in FIG. 11, the encoding unit 14 can transmit the packet #1 from the TMDS output unit 15 by using the data transmission regions 40-42 and 43-45 for transmitting the data in the format of the HDMI Standard, and transmit the packet #2 from the TMDS output unit 15 by using the data transmission unallocated regions 50-52 and 53-55 of the communication line defined by the HDMI. The regions thus respectively chosen for the transmission of the packets #1 and #2 may be reversed.

Further, the video/audio HDMI encoding unit 14 generates and outputs an attribute information indicating that two images are transmitted from the different video sources, and which of the packets #1 and #2 is transmitted by way of the data transmission regions 40-42 and 43-45 for transmitting the data in the format of the HDMI Standard and which of the packets #1 and #2 is transmitted by way of the data transmission unallocated regions 50-52 and 53-55. The attribute information is transmitted in the same manner as described in the exemplary embodiments 1-3.

Similarly to the exemplary embodiment 3, the DVD player 10 has to determine before the transmission whether the TV 20 can receive the two different images separately. Similarly to the exemplary embodiment 3, there are two ways for the DVD player 10 to determine whether the different images can be received as described below. One of them is to recite the information indicating that the video signals transmitted in the present exemplary embodiment can be received in the EDID (Extended Display Identification Data) 31, so that the DVD player 10 can determine whether the two images can be separately received by reading the EDID of the TV 20.

The other is for the DVD player 10 to obtain the information on whether the video signals transmitted from the TV 20 according to the present exemplary embodiment can be received by communicating with the TV 20 through the CEC (Consumer Electronics Control) 32. In either way, it is confirmed whether the TV 20 can receive the two different images. Then, the DVD player 10 starts to transmit the images.

The attribute information determination unit 26 of the TV 20 is further configured to handle one of the packet data transmitted by using the HDMI-compliant data transmission regions 40-42 and 43-45 and the packet data transmitted by using the data transmission unallocated regions 50-52 and 53-55 as the data containing the video signal #1 and the audio signal #1, and handle the other as the data containing the video signal #2 and the audio signal #2 based on the value of the received attribute information.

Based on the determination result obtained by the attribute information determination unit 26, the video/audio decoding unit of the TV 20 decodes one of the packet data transmitted by using the HDMI-compliant data transmission regions 40-42 and 43-45 and the packet data transmitted by using the data transmission unallocated regions 50-52 and 53-55 as the data containing the video signal #1 and the audio signal #1, and decodes the other as the data containing the video signal #2 and the audio signal #2. Then, the video/audio decoding unit outputs the decoded data as the video signal #1 and the video signal #2 from the video signal output unit 24 and as the audio signal #1 and the audio signal #2 from the audio signal output unit 25.

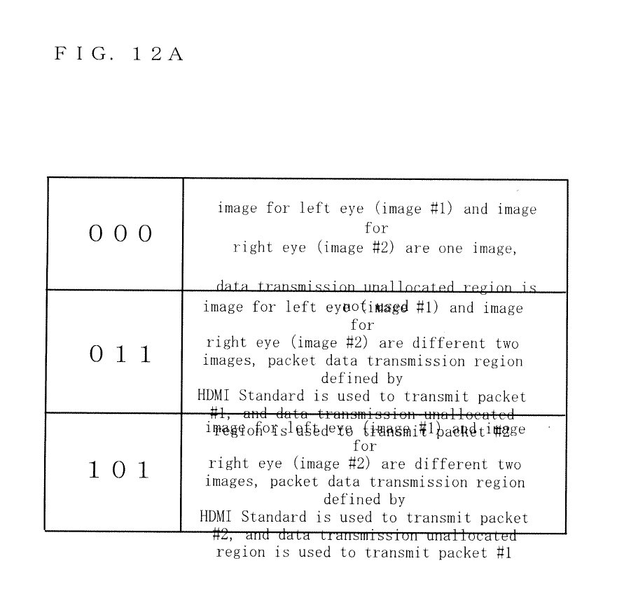

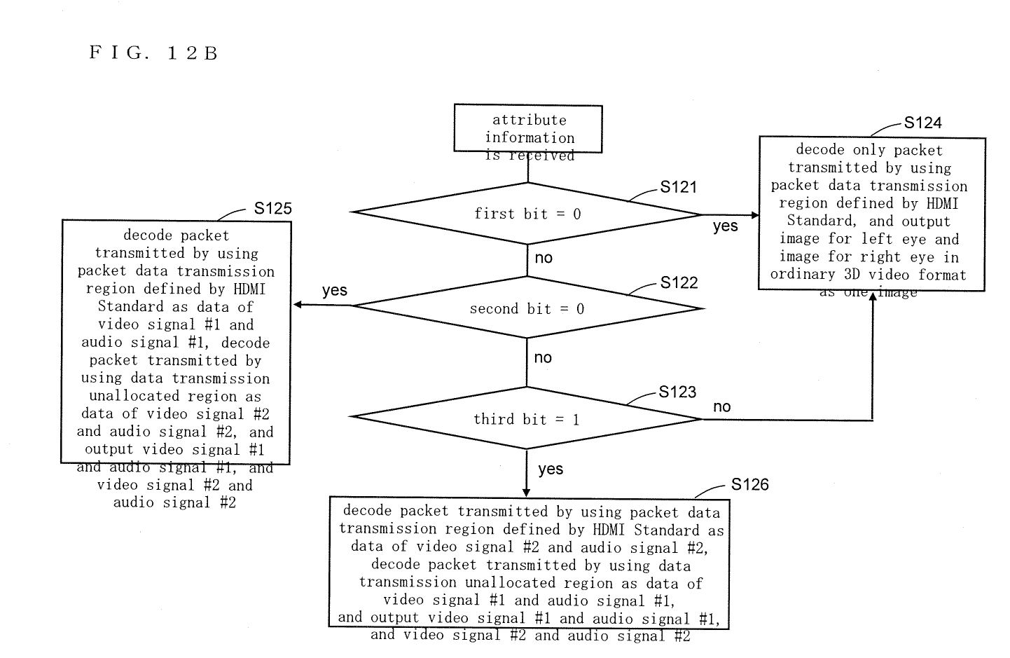

Examples of the attribute information are described referring to FIG. 12A. The drawing illustrates the following three examples.

First, the attribute information takes the value of “000” in the case where the image #1 and the image #2 are an image for left eye right eye (no packet data in the data transmission unallocated region).

Second, the attribute information takes the value of “011” in the case where the video signals #1 and #1 are two different images, and the packet data containing the video signal #1 and the audio signal #1 (packet #1) is transmitted by using the HDMI-compliant data transmission region, while the packet data containing the video signal #2 and the audio signal #2 (packet #2) is transmitted by using the data transmission unallocated region.

Third, the attribute information takes the value of “101” in the case where the video signals #1 and #2 are two different images, and the packet data containing the video signal #2 and the audio signal #2 (packet #2) is transmitted by using the HDMI-compliant data transmission region, while the packet data containing the video signal #1 and the audio signal #1 (packet #1) is transmitted by using the data transmission unallocated region.

The attribute information is determined by the attribute information determination unit 26 in accordance with a flow chart illustrated in FIG. 12B. When the attribute information is received, the first bit is checked (Step S121), the second bit is checked (Step S122), and the third bit is checked (Step S123). When the first bit=0 is known by checking the first bit (Step S121), only the packet data transmitted by way of the HDMI-compliant data transmission region is decoded, and the image for left eye and the image for right eye are paired and outputted as an image in the conventional 3D video format (Step S124). When the first bit=1 is known by the checking the first bit (Step S121), the second bit is checked next (Step S122). When the second bit=1 is known by checking the second bit (Step S122), the packet data transmitted by way of the HDMI-compliant data transmission region is decoded as the data containing the video signal #1 and the audio signal #1 (packet #1), while the packet data transmitted by way of the data transmission unallocated region is decoded as the data containing the video signal #2 and the audio signal #2 (packet #2) (Step S125). The packet #1 (video signal #1 and audio signal #1) and the packet #2 (video signal #2 and audio signal #2) are separately transmitted. When the second bit=0 is known by checking the second bit (Step S122), the third bit is checked (Step S123). When the third bit=1 is known by checking the third bit (Step S123), the packet data transmitted by way of the HDMI-compliant data transmission region is decoded as the data containing the video signal #2 and the audio signal #2 (packet #2), and the audio packet data transmitted by way of the data transmission unallocated region is decoded as the data containing the video signal #1 and the audio signal #1 (packet #1) (Step S126). The packet #1 (video signal #1 and audio signal #1) and the packet #2 (video signal #2 and audio signal #2) are separately transmitted. When the third bit=0 is known by checking the third bit, the same process as the first bit=0 (Step S124) is carried out.

As described so far, the present exemplary embodiment is technically advantageous in that the two different video and audio signals generated by the video/audio transmission device (DVD player 10) can be transmitted to the video/audio reception device (TV 20) at the same time, and the video/audio reception device (TV 20) can separately output the two different video and audio signals transmitted from the video/audio transmission device.

The present invention is not necessarily limited to the exemplary embodiments described so far, and can be variously modified. It is needless to say that the present invention encompasses such modifications.

### INDUSTRIAL APPLICABILITY

As described so far, the video/audio reception device and the video/audio transmission device according to the present invention can transmit and receive to and from each other a larger volume of information than in the prior art through data transmission. These devices are advantageously applicable to video/audio transmission devices such as DVD player, DVD recorder, BD (Blu-ray Disc) player, and BD recorder, and video/audio reception devices such as TV, AV amplifier, and projector.

### DESCRIPTION OF REFERENCE SYMBOLS

10 DVD player (video/audio transmission device)
11 HDMI transmission LSI
12 video signal input unit
13 audio signal input unit
14 video/audio HDMI encoding unit (video/audio encoding unit)
15 TMDS output unit (differential signal output unit)
16 transmission device control CPU
20 TV (video/audio reception device)
21 HDMI reception LSI
22 TMDS input unit (differential signal input unit)
23 video/audio HDMI decoding unit (video/audio decoding unit)
24 video signal output unit
25 audio signal output unit
26 attribute information determination unit
27 reception device control CPU
30 HDMI cable
CH0, CH1, CH2 TMDS channel
31 EDID
32 CEC line
33 video signal combining unit

What is claimed is:

1. A video/audio transmission device comprising:
a video/audio encoding unit configured to encode an inputted video/audio signal in a format compliant with a predetermined technical standard; and
a differential signal output unit configured to output the encoded data in the form of a differential signal defined by the predetermined technical standard, wherein
the differential signal output unit appends the data encoded by the video/audio encoding unit to a data transmission unallocated region of a communication line defined by the predetermined technical standard and then transmits the resulting data,
the video/audio encoding unit outputs an attribute information indicating whether the encoded data transmitted by using a data transmission region of the communication line defined by the predetermined technical standard for transmitting the data encoded in the format compliant with the predetermined technical standard and the encoded data transmitted by using the data transmission unallocated region of the communication line are both encoded from a signal.

2. The video/audio transmission device as claimed in claim 1, wherein
the predetermined technical standard is HDMI Standard.

3. The video/audio transmission device as claimed in claim 2, wherein
the video/audio encoding unit has a packet generation feature, wherein the differential signal output unit outputs an arbitrary packet data to the data transmission unallocated region.

4. The video/audio transmission device as claimed in claim 3, wherein
the differential signal output unit outputs a packet data defined by the HDMI Standard to the data transmission unallocated region.

5. The video/audio transmission device as claimed in claim 4, wherein
the video/audio encoding unit encodes an inputted video signal or audio signal into a packet data defined by the HDMI Standard, and
the differential signal output unit separately outputs the encoded packet data to the data transmission unallocated region and the data transmission region defined by the HDMI Standard.

6. The video/audio transmission device as claimed in claim 4, wherein
the packet data defined by the HDMI Standard and generated by the video/audio encoding unit is one or at least two of Audio Sample Packet, Audio Clock Regeneration Packet, Audio InfoFrame Packet, One-bit Audio Sample Packet, DST Audio Packet, and HBR Audio Stream Packet.

7. The video/audio transmission device as claimed in claim 4, wherein
the packet data defined by the HDMI Standard and outputted by the differential signal output unit is MPEG Source InfoFrame.

8. The video/audio transmission device as claimed in claim 1, wherein
the attribute information includes an information indicating whether there is any data in the data transmission unallocated region.

9. The video/audio transmission device as claimed in claim 1, wherein
the video/audio signal is configured in a 3D video format.

10. The video/audio transmission device as claimed in claim 9, wherein
an information indicating that the video/audio signal configured in the 3D video format can be received is read from an EDID (Extended Display Identification Data) transmitted from a reception device which receives the video/audio signal.

11. The video/audio transmission device as claimed in claim 9, wherein
an information indicating that the video/audio signal configured in the 3D video format can be received is read from a reception device which receives the video/audio signal via a CEC (Consumer Electronics Control).

12. The video/audio transmission device as claimed in claim 8, wherein
the attribute information indicates which of a first image and a second image configured in a 3D video format is paired with an audio data transmitted by using the data transmission data unallocated region.

13. A video/audio reception device comprising:
a differential signal input unit configured to input therein a differential signal defined by a predetermined technical standard;
a video/audio decoding unit configured to decode a data encoded in a format compliant with the predetermined technical standard and transmitted in the form of the differential signal inputted to the differential signal input to obtain a video/audio signal; and
an attribute information determination unit configured to determine based on an inputted attribute information whether the encoded data transmitted by using a data transmission region of a communication line defined by the predetermined technical standard for transmitting the data encoded in the format compliant with the predetermined technical standard and the encoded data transmitted by using a data transmission unallocated region of the communication line are both encoded from a signal, wherein
the differential signal input unit inputs therein the encoded data transmitted by using the data transmission region of the communication line defined by the predetermined technical standard for transmitting the data encoded in the format compliant with the predetermined technical standard and the encoded data transmitted by using the data transmission unallocated region of the communication line,
the video/audio decoding unit decodes both of the encoded data inputted to the differential signal input unit by using the data transmission region and the data transmission unallocated region, and
the video/audio decoding unit decodes the encoded data after combining the encoded data in the form of a signal when a result of the determination by the attribute information determination unit is affirmative.

14. The video/audio reception device as claimed in claim 13, wherein
the predetermined technical standard is HDMI Standard.

15. The video/audio reception device as claimed in claim 14, wherein
in the case where an arbitrary packet data is included in the data transmission unallocated region, the video/audio decoding unit decodes the arbitrary packet data.

16. The video/audio reception device as claimed in claim 15, wherein
in the case where an audio packet data defined by the HDMI Standard is included in the data transmission unallocated region, the video/audio decoding unit decodes the audio packet data into an audio signal.

17. The video/audio reception device as claimed in claim 15, wherein
in the case where a video packet data defined by the HDMI Standard is included in the data transmission unallocated region, the video/audio decoding unit decodes the video packet data into a video signal.

18. The video/audio reception device as claimed in claim 13, wherein
the video/audio decoding unit decodes audio packet data respectively transmitted by using the data transmission unallocated region and the data transmission region defined by the HDMI Standard after combining the audio packet data into an audio signal.

19. The video/audio reception device as claimed in claim 13, wherein
the video/audio decoding unit decodes video packet data respectively transmitted by using the data transmission unallocated region and the data transmission region defined by the HDMI Standard after combining the video packet data into a video signal.

20. The video/audio reception device as claimed in claim 13, wherein
the video/audio decoding unit decodes video packet data respectively transmitted by using the data transmission unallocated region and the data transmission region defined by the HDMI Standard into different video signals.

21. The video/audio reception device as claimed in claim 13, wherein
the attribute information determination unit determines whether there is any data in the data transmission unallocated region.

22. The video/audio reception device as claimed in claim 13, wherein
the video/audio signal is configured in a 3D video format.

23. The video/audio reception device as claimed in claim 22, wherein
an information indicating that the video/audio signal configured in the 3D video format can be received is additionally recited in an EDID (Extended Display Identification Data).

24. The video/audio reception device as claimed in claim 22, wherein
an information indicating that the video/audio signal configured in the 3D video format can be received is transmitted via a CEC (Consumer Electronics Control).

25. The video/audio reception device as claimed in claim 21, wherein
the attribute information determination unit determines which of a first image and a second image configured in a 3D video format is paired with an audio data transmitted by using the data transmission data unallocated region.
